(19) United States
(12) Patent Application Publication
(10) Pub. No.: US 2022/0042845 A1
(43) Pub. Date: Feb. 10, 2022

(54) INSPECTION DEVICE FOR EMERGENCY LIGHTING EQUIPMENT

(71) Applicant: Wentai Technology Corporation, New Taipei City (TW)

(72) Inventor: Yun-Yuan YEH, New Taipei City (TW)

(21) Appl. No.: 17/321,412

(22) Filed: May 15, 2021

(30) Foreign Application Priority Data
Aug. 4, 2020 (TW) 109210032

(51) Int. Cl. G01J 1/18; H05B 47/19

(52) U.S. Cl. CPC G01J 1/18; G01J 2001/4247; H05B 47/19

(57) ABSTRACT

An inspection device including a switch, a photo sensing element and a control module, where the switch is coupled between an alternating current power source and an emergency lighting device and is switched by the control module; the photo sensing element is used for sensing a lighting state of the emergency lighting device; and the control module is used to receive a command from a handheld device and transmit a detection result to the handheld device via a wireless communication.

### BACKGROUND OF THE INVENTION

### Field of the Invention

The present invention relates to an inspection device for emergency lighting equipment, especially to a device that can quickly check whether the emergency lighting equipment is normal.

### DESCRIPTION OF THE RELATED ART

Please refer to FIG. 1, which is a schematic diagram of a conventional emergency lighting device. As shown in FIG. 1, a conventional emergency lighting device 10 is located on a wall 20 of a stairwell and is connected to an AC (alternating current) power socket 21 located at a height of the wall 20.

The conventional emergency lighting device 10 is usually powered by an AC power source, and must be automatically lit in the event of a power failure. However, it is impossible to judge by appearance whether the battery, the control circuit and the lamp inside the conventional emergency lighting device 10 are all normally functioning, and it will be too late to discover that the conventional emergency lighting device 10 is malfunctioning when a power outage occurs. Therefore, it is necessary to regularly inspect the conventional emergency lighting device 10 and maintain the readiness of the conventional emergency lighting device 10, so as to ensure that the conventional emergency lighting device 10 will be lit immediately to provide emergency lighting when a power outage takes place.

In addition, although the official firefighting units have the duty to regularly conduct inspections on emergency exit signs and emergency lighting devices, however, as there are gaps between the inspections, the emergency exit signs and emergency lighting devices cannot be guaranteed to be normal every day. Moreover, for each inspection, a switch in the power box must be operated to power off the emergency lighting device 10 to confirm whether the emergency lighting device 10 is normal in providing emergency lighting, which is not only time-consuming and labor-intensive, but also inefficient.

To solve the above problems, a novel inspection device for emergency lighting equipment is needed.

### SUMMARY OF THE INVENTION

The main objective of the present invention is to provide an inspection device that can control the connection with an alternating current power source of an emergency lighting apparatus by remote control or manual control, and automatically determine the lighting state of the emergency lighting apparatus, thereby quickly completing the inspection operation of the emergency lighting apparatus.

To achieve the aforementioned objective, an inspection device for emergency lighting equipment is proposed, including:

a switch having an input end, a control end and an output end, the input end being used to couple with an alternating current power source, and the output end being used to couple with an emergency lighting device;

a photo sensing element for sensing a lighting state of the emergency lighting device; and

a control module, powered by the alternating current power source and having a control circuit, a wireless communication unit and an antenna, where the control circuit is coupled to the wireless communication unit to receive commands from a handheld device and transmit a detection result to the handheld device via the antenna; the control circuit is coupled to the photo sensing element to receive the lighting state of the emergency lighting device and generate the detection result according to the lighting state; and the control circuit is coupled to the control end of the switch to control an electrical connection between the input end and the output end of the switch.

In one embodiment, the switch further includes a manual control end for an operator to manually determine whether to connect the alternating current power source to the emergency lighting device via the output end of the switch.

In one embodiment, the switch is a relay.

In one embodiment, the wireless communication unit uses a wireless communication mechanism to communicate with the handheld device, and the wireless communication mechanism can be infrared, RF, WiFi, Bluetooth, or ZigBee.

In one embodiment, the wireless communication mechanism is an encoded wireless communication mechanism.

In one embodiment, the control module generates the detection result according to a comparison of the lighting state with a threshold.

In one embodiment, the emergency lighting device includes an exit instruction text or pattern.

In possible embodiments, the handheld device can be a remote control or a smart phone.

In one embodiment, when the handheld device is the remote control, it includes an inspection button and a reset button.

In one embodiment, when the handheld device is a smart phone, it provides an inspection button icon and a reset button icon on a display screen.

### BRIEF DESCRIPTION OF THE DRAWINGS

FIG. 1 is a schematic diagram of a conventional emergency lighting device.

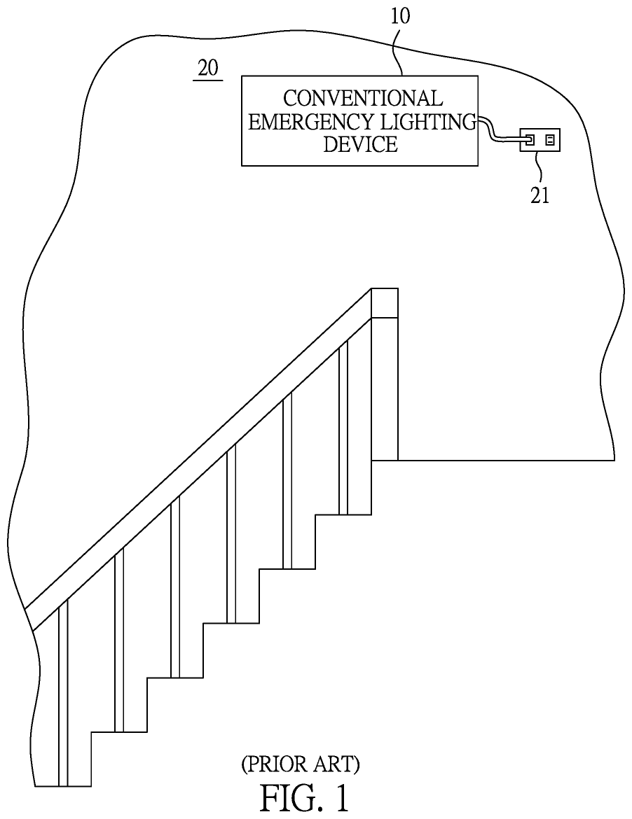

FIG. 2 illustrates a block diagram of an embodiment of the inspection device for emergency lighting equipment of the present invention.

### DETAILED DESCRIPTION OF THE PREFERRED EMBODIMENTS

The principle of the present invention is to use a switch device having photo sensing function to be coupled between an alternating current power source and an emergency lighting apparatus, and make the switch device provide two control modes, manual control and wireless control, to facilitate the inspection operations on the emergency lighting equipment for inspectors.

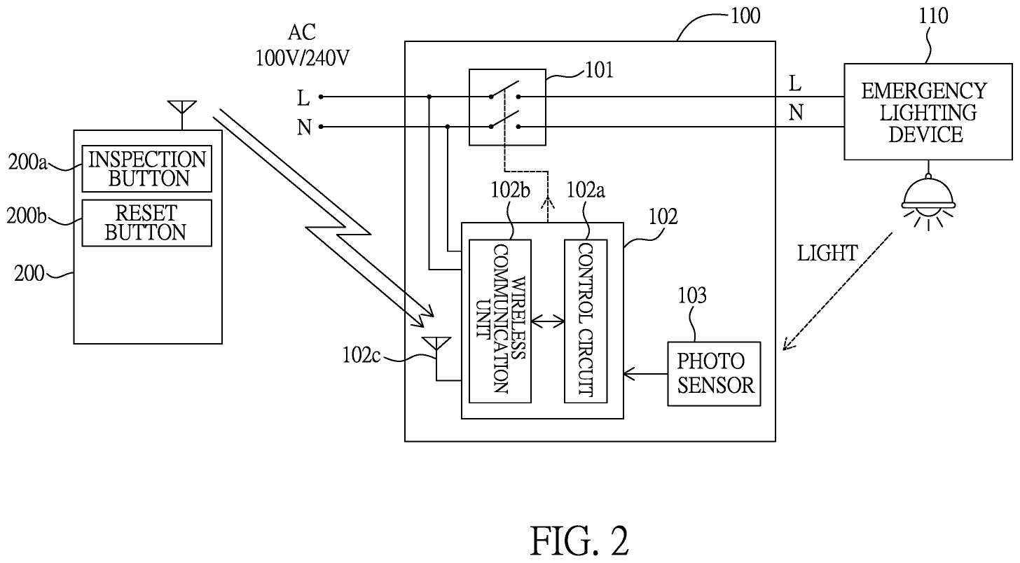

Please refer to FIG. 2, which illustrates a block diagram of an embodiment of the inspection device for emergency lighting equipment of the present invention. As shown in FIG. 2, an emergency lighting equipment inspection device 100 includes a switch 101, a control module 102 and a photo sensor 103.

The switch 101, which can be a relay, has an input end, a control end and an output end. The input end is used to couple with an alternating current power source AC, and the control end is coupled to the control module 102 to receive the control of the control module 102 to determine whether to connect the alternating current power source AC to an emergency lighting device 110 via the output end. In addition, the control end may also include a manual control end for an inspector to operate manually to determine whether to connect the alternating current power source AC to the emergency lighting device 110 via the output end.

The control module 102 is powered by the alternating current power source AC and has a control circuit 102a, a wireless communication unit 102b and an antenna 102c, where the control circuit 102a is coupled with the wireless communication unit 102b for receiving a command from a handheld device 200 and transmitting a detection result to the handheld device 200 via the antenna 102c; the control circuit 102a is coupled with the photo sensing element 103 to receive a lighting state of the emergency lighting device 110; and the control circuit 102a is coupled to the control end of the switch 101 to control the electrical connection between the input end and the output end of the switch 101. In addition, the wireless communication unit 102b can communicate with the handheld device 200 in a wireless manner such as infrared, RF, WiFi, Bluetooth, or ZigBee, and the wireless communication unit 102b and the handheld device 200 can adopt a coded communication mechanism.

The emergency lighting device 110 has a lamp and a battery, and preferably, it has an exit instruction text or pattern.

The handheld device 200 can be a remote control or a smart phone, where the remote control can have an inspection button 200a and a reset button 200b, and the smart phone can display an inspection button icon and a reset button icon on a display screen thereof.

During an inspection operation, an inspector can press the inspection button 200a (or the inspection button icon) on the handheld device 200 to notify the control module 102 to turn off the switch 101. After the switch 101 is turned off, the battery inside the emergency lighting device 110 will start to supply power to the lamp to make the emergency lighting device 110 emit light. Then, the photo sensing element 103 will feed back a lighting state (brightness) of the emergency lighting device 110 to the control module 102, and the control module 102 will generate an operation state judgment result (normal or malfunction) according to the comparison of the lighting state (brightness) with a threshold, and transmit the operation state judgment result (normal or malfunction) to the handheld device 200 via the wireless communication unit 102b and the antenna 102c to inform the inspector of the current state of the emergency lighting device 110, where, when the lighting state (brightness) is greater than the threshold, the operating state judgment result will have a content representing normal, and when the lighting state (brightness) is not greater than the threshold, the operating state judgment result will have a content representing malfunction. After learning the current state of the emergency lighting device 110, if the function is normal, the inspector can press the reset button 200b (or reset button icon) to request the control module 102 to turn on the switch 101 to reconnect the emergency lighting device 110 to the alternating current power source AC to have the battery charged by the alternating current power source AC; if the function is not normal, the inspector can notify the maintenance personnel to repair the emergency lighting device 110.

In addition, the inspector can also disconnect the alternating current power source AC from the emergency lighting device 110 by pressing the manual control end of the switch 101, and visually observe the lighting state of the emergency lighting device 110 (bright or dark) to determine the current state (normal or malfunction) of the emergency lighting device 110.

Thanks to the arrangements mentioned above, the present invention possesses the following advantages:

The inspection device of the present invention can control the connection with an alternating current power of an emergency lighting apparatus by remote control or manual control, and automatically determine the lighting state of the emergency lighting apparatus, thereby quickly completing the inspection operation of the emergency lighting apparatus.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. An inspection device for emergency lighting equipment, comprising:
a switch having an input end, a control end and an output end, the input end being used to couple with an alternating current power source, and the output end being used to couple with an emergency lighting device;
a photo sensing element for sensing a lighting state of the emergency lighting device; and
a control module, powered by the alternating current power source and having a control circuit, a wireless communication unit and an antenna, where the control circuit is coupled to the wireless communication unit to receive commands from a handheld device and transmit a detection result to the handheld device via the antenna; the control circuit is coupled to the photo sensing element to receive the lighting state of the emergency lighting device and generate the detection result according to the lighting state; and the control circuit is coupled to the control end of the switch to control an electrical connection between the input end and the output end of the switch.

2. The inspection device for emergency lighting equipment as disclosed in claim 1, wherein the switch further includes a manual control end for an operator to manually determine whether to connect the alternating current power source to the emergency lighting device via the output end of the switch.

3. The inspection device for emergency lighting equipment as disclosed in claim 1, wherein the switch is a relay.

4. The inspection device for emergency lighting equipment as disclosed in claim 1, wherein the wireless communication unit uses a wireless communication mechanism to communicate with the handheld device, and the wireless communication mechanism is selected from a group consisting of infrared, RF, WiFi, Bluetooth, and ZigBee.

5. The inspection device for emergency lighting equipment as disclosed in claim 4, wherein the wireless communication mechanism is an encoded wireless communication mechanism.

6. The inspection device for emergency lighting equipment as disclosed in claim 1, wherein the control module generates the detection result according to a comparison of the lighting state with a threshold.

7. The inspection device for emergency lighting equipment as disclosed in claim 1, wherein the emergency lighting device includes an exit instruction text or pattern.

8. The inspection device for emergency lighting equipment as disclosed in claim 1, wherein the handheld device is a remote control or a smart phone.

9. The inspection device for emergency lighting equipment as disclosed in claim 8, wherein when the handheld device is the remote control, it includes an inspection button and a reset button.

10. The inspection device for emergency lighting equipment as disclosed in claim 8, wherein when the handheld device is a smart phone, it provides an inspection button icon and a reset button icon on a display screen.
